(19) United States
(12) Patent Application Publication
(10) Pub. No.: US 2010/0122897 A1
(43) Pub. Date: May 20, 2010

(54) Keypad, Keypad Matrix and Electronic Device

(75) Inventor: Mats O. Larsson, Kavlinge (SE)

Correspondence Address: MCDONNELL BOEHNEN HULBERT & BERGHOFF;LLP/SEMC, 300 S.WACKER DRIVE, SUITE 3100, CHICAGO, IL, 60606, US

(73) Assignee: SONY ERICSSON MOBILE COMMUNICATIONS AB, Lund (SE)

(21) Appl. No.: 12/271,141

(22) Filed: Nov. 14, 2008

(51) Int. Cl. H01H 13/702

(52) U.S. Cl. 200/5 A

(57) ABSTRACT

A keypad, a keypad matrix and an electronic device comprising a keypad are disclosed. The keypad comprises a plurality of keys and a keypad matrix. The keypad matrix comprises a plurality of conductive traces. At least three conductive traces are coupled to an actuation area of the keypad matrix which is associated with a key.

### FIELD OF THE INVENTION

The invention relates to a keypad, a keypad matrix and an electronic device. The invention relates in particular to a keypad having a keypad matrix which comprises a plurality of conductive traces and a portable electronic device employing the same.

### BACKGROUND OF THE INVENTION

Electronic devices, such as portable electronic devices frequently comprise a user interface that includes a keypad having a plurality of keys. Such a keypad allows a user to enter control commands or other data. Examples for portable electronic devices include mobile phones, cordless phones, personal digital assistants (PDAs) and similar. Actuation of a key of the keypad may be detected electrically. For illustration, actuation of a key may cause an electrical contact to be established between two conductive traces that may be provided, for example, on a printed circuit board underlying the key.

A keypad matrix comprising plural conductive traces may be used in a keypad. The keypad matrix may comprise a set of conductive row traces and a set of conductive column traces. A key may be arranged such that it acts on an area of the keypad matrix in such a manner that an electrical contact is established between one of the row traces and one of the column traces. In exemplary implementations of such a keypad matrix, one key is associated with one matrix position defined by one row trace and one column trace so that, upon actuation of the respective key, an electrical contact is established between the row trace and the column trace. When one key is associated with one matrix position, however, the number of keys is essentially determined by the number of row traces and column traces provided in the keypad matrix. For a larger number of keys, a correspondingly larger number of row and column traces may need to be provided. This may in turn require additional circuitry to be provided in order to monitor the larger number of row and column traces.

It is desirable to provide a keypad and a keypad matrix which, for a given number of column and row traces of the matrix, may allow actuation of a larger number of keys to be detected. It is further desirable to provide a keypad and keypad matrix which do not require additional processor circuitry in order to allow actuation of a larger number of keys to be detected.

### SUMMARY OF THE INVENTION

Accordingly, there is a need for an improved keypad which obviates at least some of the above-mentioned drawbacks.

According to an aspect of the invention, a keypad is provided which comprises a key arrangement and a matrix. The matrix may be arranged in proximity to the key arrangement. The key arrangement comprises a plurality of keys. The matrix comprises a plurality of conductive traces. The key arrangement is configured such that, when a key is actuated, electrical characteristics of the matrix are affected in an actuation area of the matrix which is associated with the key. The matrix is configured such that at least three conductive traces are coupled to the actuation area.

In order to couple the at least three conductive traces to the actuation area, the three conductive traces may for example have portions that extend into the actuation area. In a keypad in which at least three conductive traces are coupled to the actuation area associated with the key, actuation of the key may modify the electrical characteristics of the matrix not only in a single row trace and a single column trace of the matrix. For illustration, when two column traces and one row trace are coupled to the actuation area, upon actuation of the key an electrical contact may be established between the row trace and each one of the two column traces. In other words, actuation of the key may provide a signal at two matrix positions of the trace matrix. Therefore, there is no need to configure the matrix such that there is a one-to-one correspondence of every key of the keypad with a single matrix position.

In an exemplary embodiment, the conductive traces may be electrically insulated from each other in a state in which no key is actuated.

According to an embodiment, the plurality of conductive traces comprise a plurality of first conductive traces and a second conductive trace. The second conductive trace may be electrically insulated from the plurality of first conductive traces in a state in which no key is actuated. In an embodiment, the plurality of first conductive traces may be column traces of the matrix, and the second conductive trace may be a row trace of the matrix. In another embodiment, the plurality of first conductive traces may be row traces of the matrix, and the second conductive trace may be a column trace of the matrix. According to an embodiment, the at least three conductive traces coupled to the actuation area may comprise the second conductive trace and at least two first conductive traces of the plurality of first conductive traces. When the conductive traces are electrically insulated from each other in a state in which no key is actuated, the keypad may be configured such that, upon actuation of a key, an electrical contact is established between the conductive traces that are coupled to the actuation area associated with a key. This allows the actuated key to be identified by performing current or resistance measurements. In order to electrically insulate the conductive traces from each other, the conductive traces may be arranged so as to be spatially separated and/or so as to be separated by an insulating layer.

According to an embodiment, the matrix may be configured such that, upon actuation of the key, electrical connections are established between the second conductive trace and each first conductive trace of the at least two first conductive traces. For illustration rather than limitation, actuation of a key may result in electrical connections being established between one row trace and two column traces. In an embodiment, the row and column traces between which an electrical contact has been established by actuation of the key may be identified by applying a voltage to terminals of the row and column traces and by measuring a current flowing through, or a resistance of, a current flow path that includes the row and column traces.

According to an embodiment, the keypad may comprise a processor that is coupled to the at least two first conductive traces and to the second conductive trace. The processor may be configured to detect that the electrical connections are established. The processor may be a microprocessor integrated with the keypad. The processor may be configured to scan the row traces and column traces of the matrix to identify which key has been actuated, or which keys have been actuated. The processor may be operable to detect whether an electrical connection has been established between one row trace and one column trace, i.e., at a single matrix position, or whether electrical connections have been established between one row trace and two column traces, i.e., at two matrix positions.

According to an embodiment, the matrix may comprise another actuation area. The other actuation area may be associated with another key of the plurality of keys. The second conductive trace and one of the at least two first conductive traces are coupled to the other actuation area of the matrix. The actuation area and the other actuation area may be spatially disjoint. In this embodiment, at least one of the first conductive traces and the second conductive trace may be coupled to different actuation areas associated with different keys. Thereby, enhanced versatility in associating keys with matrix positions may be achieved.

In an embodiment, each actuation area of the matrix may be associated with only one key of the keypad. Thereby, the keypad may be configured to have a simple mechanical construction.

According to an embodiment, the key arrangement may comprise a first set of keys, and the matrix may comprise a first set of actuation areas associated with the first set of keys. The matrix may be configured such that respectively at least three conductive traces are coupled to each actuation area of the first set of actuation areas. The key arrangement may further comprise a second set of keys, and the matrix may further comprise a second set of actuation areas associated with the second set of keys. The matrix may be configured such that respectively two conductive traces are coupled to each actuation area of the second set of actuation areas. In this embodiment, the matrix may be configured such that two conductive traces or at least three conductive traces are coupled to the various actuation areas. Therefore, a correspondence of keys and matrix positions may be established in which a key may affect electrical properties of the matrix in one matrix position, or in a plurality of matrix positions.

According to another aspect, a portable electronic device is provided which comprises a keypad. The keypad may be configured as a keypad according to an embodiment. In one implementation, the keypad may comprise a key arrangement and a matrix arranged in proximity to the key arrangement. The key arrangement may comprise a plurality of keys. The matrix may comprise a plurality of conductive traces. The key arrangement may be configured such that, when a key is actuated, electrical characteristics of the matrix are affected in an actuation area of the matrix that is associated with the key. The matrix may be configured such that at least three conductive traces are coupled to the actuation area.

According to yet another aspect, a keypad matrix is provided. The keypad matrix comprises a plurality of first conductive traces and a second conductive trace which is electrically insulated from the plurality of first conductive traces. The keypad matrix comprises a plurality of actuation areas. At least two first conductive traces of the plurality of first conductive traces and the second conductive trace are coupled to an actuation area of the plurality of actuation areas.

In an embodiment, the first conductive traces may be column traces of the matrix, and the second conductive trace may be a row trace of the matrix. In another embodiment, the first conductive traces may be row traces of the matrix, and the second conductive trace may be a column trace of the matrix. The second conductive trace may be one of a plurality of second conductive traces comprised by the matrix.

When two first conductive traces are coupled to the actuation area, an electrical contact may be established between the second conductive trace and each one of the two first conductive traces when the respective key is actuated. This provides enhanced versatility in designing the keypad matrix, for one key of the keypad matrix may be associated with plural matrix positions.

According to an embodiment, the plurality of actuation areas may be arranged in the keypad matrix so that the actuation areas are spatially disjoint. In an embodiment, there may be a one-to-one correspondence of actuation areas and keys, i.e., each actuation area may be associated with one key of the keypad.

According to an embodiment, the keypad matrix may be configured such that conductive extensions of the at least two first conductive traces are interlaced with conductive extensions of the second conductive trace in the actuation area. This configuration allows an electrical contact to be readily established when a conductive material is brought into abutment with the actuation area.

According to an embodiment, the keypad matrix may be configured such that one first conductive trace of the at least two first conductive traces and the second conductive trace extend into another actuation area of the plurality of actuation areas.

According to an embodiment, the matrix may comprise a first set of actuation areas and may be configured such that respectively at least two first conductive traces and the second conductive trace are coupled to each actuation area of the first set of actuation areas. According to an embodiment, the trace matrix may comprise a second set of actuation areas and may be configured such that respectively one first conductive trace and the second conductive trace are coupled to each actuation area of the second set of actuation areas. In a thus configured keypad matrix, actuation areas coupled to two conductive traces and actuation areas coupled to at least three conductive traces may be combined in a keypad matrix, depending on the number of keys to be supported.

According to another aspect of the invention, a method of determining a user input to a keypad is provided. The method comprises providing a keypad which comprises a plurality of keys and a keypad matrix, the keypad matrix comprising a plurality of conductive traces; monitoring electrical characteristics of the matrix; identifying at least three conductive traces of the plurality of conductive traces based on the monitoring; and determining a key of the plurality of keys based on the at least three conductive traces.

The method of determining a user input allows an actuated key to be identified based on modified electrical characteristics of the matrix that affect more than two conductive traces. The method allows, for example, an actuated key to be identified when actuation of the key establishes electrical contacts between one row trace and two column traces of the matrix.

In an embodiment, the determining may comprise verifying that the at least three conductive traces are coupled to an actuation area associated with a key. Thereby, an approximately simultaneous actuation of two keys may be discriminated from actuation of one key.

In an embodiment, the identifying may comprise determining whether a resistance of a current flow path comprising two conductive traces of the at least three conductive traces varies. Thereby, the electrical characteristics of the matrix may be readily monitored in order to identify the at least three conductive traces.

It is to be understood that the features mentioned above and features yet to be explained below can be used not only in the respective combinations indicated, but also in other combinations or in isolation, without departing from the scope of the present invention. Features of the above-mentioned aspects and embodiments may be combined in other embodiments.

### BRIEF DESCRIPTION OF THE DRAWINGS

The foregoing and additional features and advantages of the invention will become apparent from the following detailed description when read in conjunction with the accompanying drawings, in which like reference numerals refer to like elements.

FIG. 1 is a schematic block diagram representation of a portable electronic device according to an embodiment.

FIG. 2 is a schematic exploded view of a keypad according to an embodiment.

FIG. 3 is a schematic side sectional view of a key mechanism that may be used in the keypad according to an embodiment.

FIG. 4 schematically illustrates conductive traces in a keypad matrix according to an embodiment.

FIGS. 5 and 6 schematically illustrate the keypad matrix of FIG. 4 when a key is actuated.

FIG. 7 shows a table illustrating the correspondence of column traces of a keypad matrix and keys according to another embodiment.

FIG. 8 schematically illustrates conductive traces in a keypad matrix according to another embodiment.

FIG. 9 schematically illustrates portions of conductive traces in a keypad matrix according to an embodiment.

FIG. 10 is a flow diagram representation of a method of determining a user input according to an embodiment.

### DETAILED DESCRIPTION OF THE INVENTION

In the following, embodiments of the present invention will be described in detail with reference to the accompanying drawings. It is to be understood that the following description of embodiments is given only for the purpose of illustration and is not to be taken in a limiting sense. The scope of the invention is not intended to be limited by the embodiments described hereinafter or by the drawings, which are taken to be illustrative only. Rather, the scope of the invention is intended to be defined only by the appended claims and equivalents thereof.

It is to be understood that the drawings are to be regarded as being schematic representations only, and elements illustrated in the drawings are not necessarily shown to scale. Rather, the various elements are represented such that their function and general purpose become apparent to a person skilled in the art.

It is also to be understood that, in the following description of exemplary embodiments, any direct connection or coupling between functional blocks, devices, components or other physical or functional units shown in the drawings or described herein may also be implemented by an indirect connection or coupling. Functional block may be implemented in hardware, firmware, software or a combination thereof.

Further, it is to be understood that the features of the various exemplary embodiments described herein may be combined with each other, unless specifically noted otherwise.

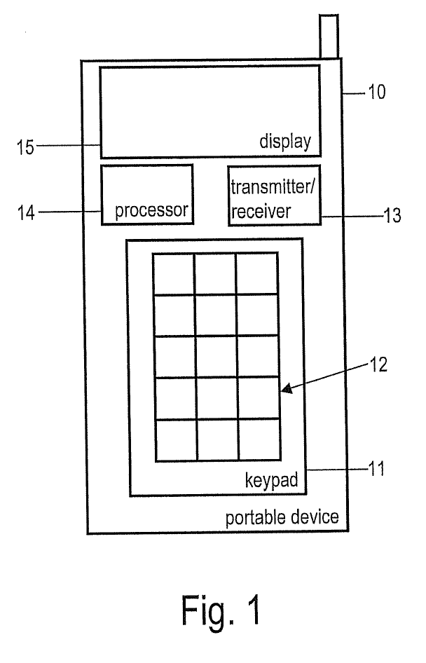

FIG. 1 is a schematic block diagram representation of a portable electronic device 10 in which a keypad or keypad matrix according to an embodiment may be implemented. The portable electronic device 10 comprises a keypad 11 having a key arrangement 12. The key arrangement 12 comprises a plurality of keys. The keypad 11 allows a user to input commands or other data into the electronic device 10. The electronic device 10 further comprises a transmitter/receiver device 13, a processor 14 and a display 15. The processor 14 may be operable to control operation of the transmitter/receiver device 13 based on an input received at the keypad 11. The processor 14 may be further operable to control the display 15 such that data are displayed on the display 15 based on the input received at the keypad 11.

In exemplary embodiments, the portable electronic device 10 may be configured as a mobile phone, as a cordless phone, as a personal digital assistant (PDA), as a portable music player, as a camera, or similar. While the portable electronic device 10 illustrated in FIG. 1 comprises a transmitter/receiver device 13 and is configured for wireless communication, in other embodiments, a keypad or keypad matrix according to an embodiment may be implemented in a portable electronic device that may not be configured for communication.

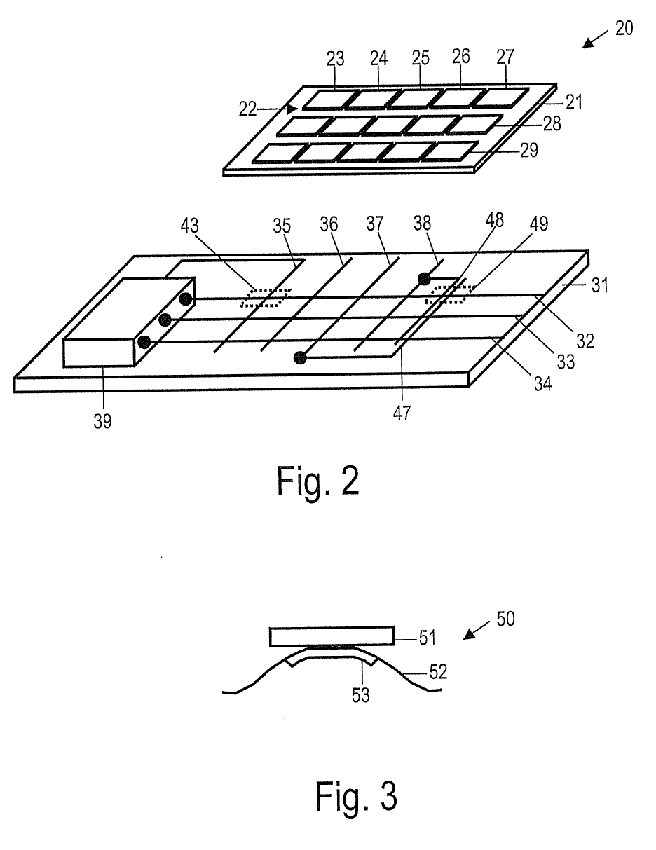

FIG. 2 is a schematic exploded view of a keypad 20 according to an exemplary embodiment. The keypad 20 of FIG. 2 may be used to implement the keypad 11 of the portable electronic device 10 of FIG. 1. The keypad 20 comprises a key arrangement 21, a keypad matrix comprising a plurality of conductive traces 32-38, and a processor 39 coupled to the conductive traces 32-38. While a specific number of keys and a specific number of conductive traces is shown in FIG. 2 for illustration, it is to be understood that other numbers of keys and other numbers of conductive traces may be implemented in other embodiments.

The key arrangement 21 comprises a plurality 22 of keys 23-29. The keys may be arranged in rows, as schematically illustrated for keys 23-27 arranged in one row. However, other arrangements may also be implemented. The keys 23-29 may be formed of a suitable material, such as plastic. The keys 23-29 of the key arrangement 21 are supported in the key arrangement 21 so as to be actuable. In one implementation, the keys 23-29 may be supported in the key arrangement such that, when a force is applied onto one of the keys, the key moves in a direction essentially perpendicular to the plane of the key arrangement. In another implementation, the keys 23-29 may be configured such that they are deformable when a force is applied.

The keypad matrix is arranged on the rear side of the key arrangement 21. The keypad matrix may be implemented such that the plurality of conductive traces 32-38 are provided on a printed circuit board (PCB) 31. As used in connection with several embodiments, the term ‘conductive trace’ generally refers to a conductive line provided in the keypad matrix. As used in connection with several embodiments, the term ‘keypad matrix’ generally relates to an arrangement that has a set of first conductive traces including at least one first conductive trace and a set of second conductive traces including at least one second conductive trace. The sets of first and second conductive traces may also be referred to as column traces and row traces, respectively. Actuation of a key may modify the electrical characteristics of the matrix at at least one conductive trace of the set of first conductive traces and at least one conductive trace of the set of second conductive traces. For illustration, upon actuation of a key, an electrical connection may established between a conductive trace comprised by the first set of conductive traces and a conductive trace comprised by the second set of conductive traces. Identifiers for the conductive traces between which an electrical connection is established upon actuation of a key may also be referred to as ‘matrix position’, it being understood that the term ‘matrix position’ may, but does not need to correspond to a specific geometrical location. While a set of first conductive traces, or column traces, 35-38 and a set of second conductive traces, or row traces, 32-34 are shown in FIG. 2 which include generally straight portions, the row and column traces may comprise curved or angled portions in other embodiments.

The keypad matrix with the plurality of conductive traces 32-38 is configured such that the conductive traces 32-38 are respectively electrically insulated from each other in a state in which no key of the key arrangement 21 is actuated.

The keypad matrix comprises a plurality of actuation areas that are associated with the keys 23-29 of the keypad. In an embodiment, the actuation areas that are associated with the keys of the keypad may be spatially disjoint. In an embodiment, each actuation area may be associated with one key of the keypad only. An actuation area 43 associated with key 23 and an actuation area 49 associated with key 27 is schematically illustrated in FIG. 2. The keypad is configured such that actuation of one of the keys may affect electrical characteristics of the keypad in the associated actuation area. In an embodiment, the keypad may be configured such that an electrical contact is established between conductive traces that are coupled to the actuation area associated with a key when the respective key is actuated. The conductive traces may be coupled to the actuation area by configuring the conductive traces such that a portion of the conductive traces extends into the actuation area.

FIG. 3 is a schematic side sectional view of a mechanism 50 for a key 51 which is configured to establish an electrical connection between conductive traces extending into an actuation area associated with the key 51. The mechanism 50 of FIG. 3 may be used for any one of the keys 23-29 of the keypad 20 of FIG. 2. The mechanism 50 comprises a dome-shaped structure 52 formed of a resilient material, which provides a return force for the key 51 when the key 51 is actuated. On a side of the dome-shaped structure 52 facing the keypad matrix, a conductive material 53 is provided. When the key 51 is depressed with a sufficient force, the dome-shaped structure 52 deforms such that the conductive material 53 is brought into abutment with the conductive traces of the trace matrix extending into the respective actuation area, thereby establishing an electrical contact between the traces.

Reverting to FIG. 2, the processor 39 is coupled to the plurality of first conductive traces 35-38 and the plurality of second conductive traces 32-34. The processor 39 may be configured to determine whether an electrical contact is established between a first conductive trace and a second conductive trace. In exemplary embodiments, the processor 39 may be configured to perform a current or resistance measurement in order to detect whether an electrical contact is established between a first conductive trace and a second conductive trace.

The keypad matrix is configured such that there is at least one actuation area 49 to which at least three conductive traces are coupled. For example, portions of the three conductive traces may extend into the actuation area 49. In the keypad 20, the keypad matrix is configured such that a portion 48 of the conductive trace 38, a portion 47 of the conductive trace 37, and a portion of the conductive trace 32 extend into the actuation area 49 associated with key 27. Similarly, at least three conductive traces extend into the actuation areas associated with keys 28 and 29, respectively. While the keypad matrix comprises actuation areas coupled to three or more conductive traces, the keypad matrix may further comprise actuation areas coupled to only two conductive traces. For illustration, the keypad matrix of the keypad 20 comprises actuation area 43 associated with key 23. Only the two conductive traces 32, 35 are coupled to the actuation area 43.

In the keypad matrix of the keypad 20, when key 23 is actuated, an electrical contact is established between the column trace 35 and the row trace 32. The processor 39 is configured to detect that the electrical contact has been established between the column trace 35 and the row trace 32, i.e., that a matrix position defined by the column trace 35 and the row trace 32 has been activated. Based on the activated matrix position, the processor 39 may determine that key 23 has been actuated. When key 27 is actuated, an electrical contact is established both between the column trace 37 and the row trace 32 and between the column trace 38 and the row trace 32. The processor 39 is configured to detect that these electrical contacts have been established, i.e., that two matrix position have been activated. Based on the activated matrix positions, the processor 39 may determine that key 27 has been actuated. Similarly, two matrix positions of the trace matrix are respectively activated when either one of keys 28 and 29 is actuated.

In the keypad matrix of the keypad 20, the same matrix position may be activated when different keys are actuated. For illustration, an electrical contact is established between column trace 37 and row trace 32 when key 25 is actuated, and also when key 27 is actuated. Similarly, an electrical contact is established between column trace 38 and row trace 32 when key 26 is actuated, and also when key 27 is actuated. However, the keypad matrix is configured such that the actuation of key 27 may be discriminated from the actuation of keys 25 and 26, respectively, for two matrix positions are activated upon actuation of key 27.

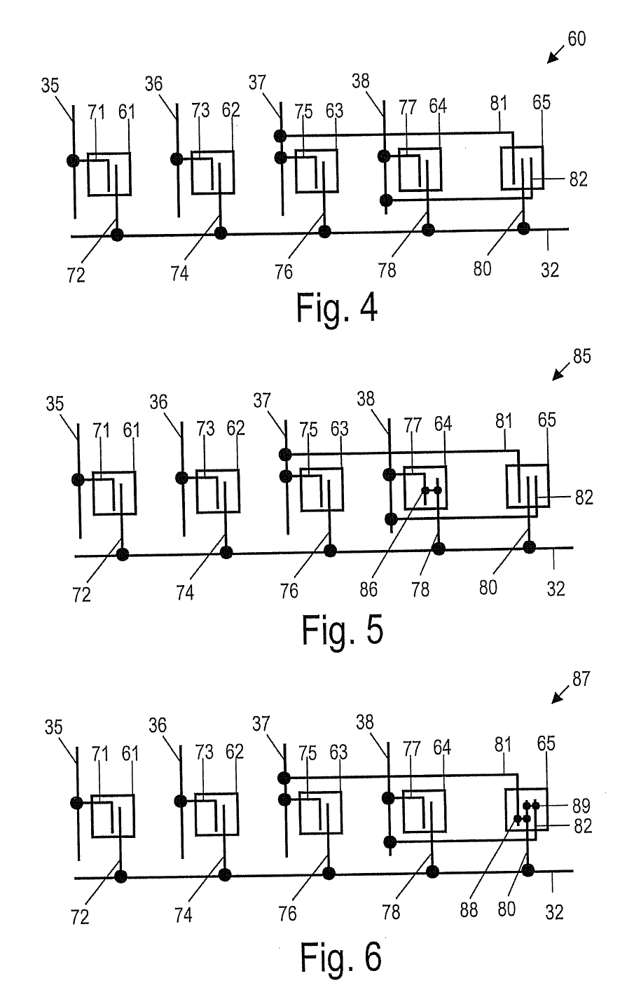

With reference to FIGS. 4-6, a keypad matrix according to an exemplary embodiment will be explained in more detail. FIG. 4 shows conductive traces of an exemplary keypad matrix 60. The arrangement of conductive traces explained with reference to FIG. 4 may be implemented in the keypad matrix of the keypad 20 of FIG. 2, for example in the portion of the keypad matrix underlying keys 23-27.

The keypad matrix of FIGS. 4-6 comprises a set of four first conductive traces, or column traces, 35-38, and a second conductive trace, or row trace, 32. The keypad matrix also comprises five actuation areas 61-65. When the keypad matrix is used in a keypad, each one of the illustrated actuation areas 61-65 is associated with one key. The traces of the keypad matrix are configured such that respectively one column trace and one row trace are coupled to the actuation areas 61-64. In the illustrated keypad matrix 60, a portion 72 of the row trace 32 and a portion 71 of the column trace 35 extend into the actuation area 61, a portion 74 of the row trace 32 and a portion 73 of the column trace 36 extend into the actuation area 62, a portion 76 of the row trace 32 and a portion 75 of the column trace 37 extend into the actuation area 63, and a portion 78 of the row trace 32 and a portion 77 of the column trace 38 extend into the actuation area 64. The traces of the keypad matrix are configured such that two column traces and one row trace are coupled to the actuation area 65. In the illustrated keypad matrix, a portion 81 of the column trace 37, a portion 82 of the column trace 38 and a portion 80 of the row trace 32 extend into the actuation area 65.

FIG. 5 is a schematic illustration 85 of the keypad matrix of FIG. 4 in a state in which the key associated with actuation area 64 is actuated. Upon actuation of this key, an electrical contact is established between the column trace 38 and the row trace 32, as schematically indicated at 86. Current or resistance measurements may be employed to detect that the contact 86 is established.

FIG. 6 is a schematic illustration 87 of the keypad matrix of FIG. 4 in a state in which the key associated with actuation area 65 is actuated. Upon actuation of this key, an electrical contact is established both between the column trace 37 and the row trace 32, as schematically indicated at 88, and between the column trace 38 and the row trace 32, as schematically indicated at 89. While in each one of the two states illustrated FIGS. 5 and 6 an electrical contact is established between the column trace 38 and the row trace 32, actuation of the key associated with the actuation area 64 may be discriminated from the actuation of the key associated with the actuation area 65, for an electrical contact between the column trace 37 and the row trace 32 is additionally established when the key associated with actuation area 65 is actuated. In other words, while the actuation of the key associated with actuation area 64 activates one matrix position corresponding to column trace 38 and row trace 32, actuation of the key associated with actuation area 65 activates two matrix position corresponding to column trace 38 and row trace 32 and to column trace 37 and row trace 32, respectively.

It will be appreciated that the keypad matrix explained with reference to FIGS. 4-6, in which at least one actuation area is coupled to at least three conductive traces, provides enhanced versatility in associating keys with matrix positions of the conductive matrix. For illustration, in the keypad matrix explained with reference to FIGS. 4-6, actuation of five different keys may be detected with a matrix that has four column traces.

A keypad matrix may have any suitable number of actuation areas coupled to at least three conductive traces. For illustration, while the exemplary keypad matrix 60 of FIGS. 4-6 includes one actuation area 65 coupled to three conductive traces, in other embodiments, the keypad matrix may be configured such that there are several actuation areas respectively coupled to at least three conductive traces. In other words, a keypad matrix may be configured such that, for several keys of the keypad, actuation of a key establishes an electrical contact between, for example, two column traces and a row trace of the keypad matrix.

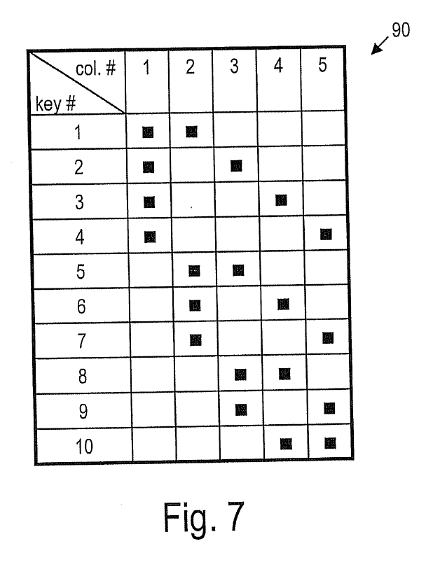

FIG. 7 shows a table 90 which illustrates a correspondence of keys and column traces activated by actuation of the respective keys in an exemplary embodiment. Table 90 illustrates the correspondence of keys and activated columns for an exemplary embodiment in which there are ten keys and five column traces. The ten keys are labeled from key ‘1’ to key ‘10’, and the five column traces are labeled from column ‘1’ to column ‘5’. Filled squares in the table indicate that, upon actuation of the respective key, an electrical contact is established between the respective column trace and a row trace.

For illustration, in the embodiment schematically represented in table 90, actuation of each one of the ten different keys respectively acts on two column traces. In one embodiment, an electrical contact may be established between the two indicated column traces and a row trace. It will be appreciated that, for the exemplary embodiment indicated in table 90, actuation of ten keys may be discriminated with a keypad matrix that has five column traces. To this end, the activated pair of column traces may be identified.

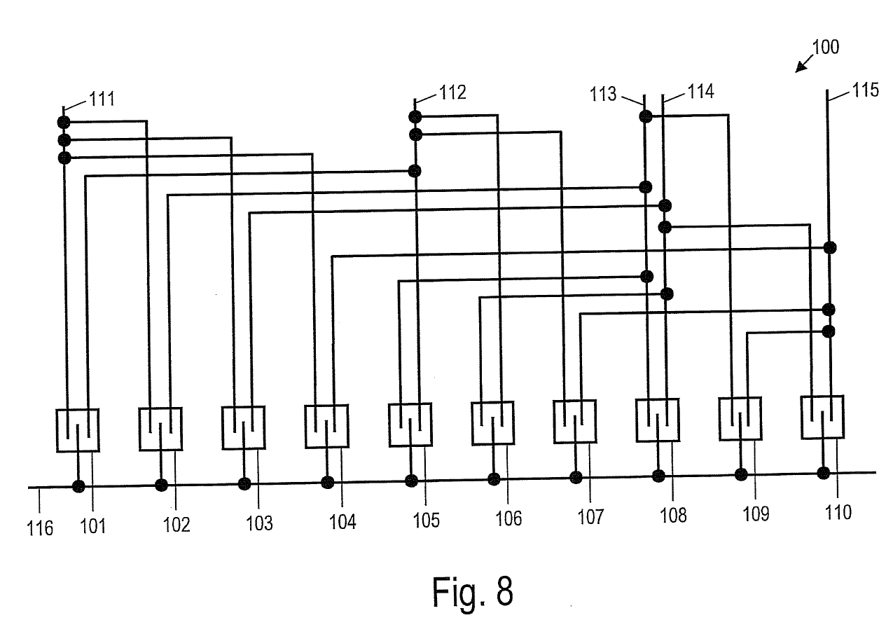

FIG. 8 is a schematic illustration of a keypad matrix 100 according to an embodiment. The keypad matrix 100 may be used to implement the correspondence of keys and column traces indicated in table 90.

The keypad matrix 100 comprises ten actuation areas 101-110 that are associated with the ten keys. The actuation areas 101-110 are spatially disjoint. Each one of the actuation areas is associated with one key only. The keypad matrix 100 further comprises five column traces 111-115 and a row trace 116. The keypad matrix 100 is configured such that, when no key is actuated, the conductive traces 111-116 are electrically insulated from each other. This may be achieved by appropriately spacing the traces and/or by interposing an insulating layer between the conductive traces in areas where the conductive traces are stacked.

The conductive traces are arranged so that two column traces are coupled to each one of the actuation areas 101-110, in accordance with the correspondence of keys and column traces indicated in table 90. For illustration, the row trace 116, the column trace 111 and the column trace 112 extend into actuation area 101. Similarly, the row trace 116, the column trace 111 and the column trace 113 extend into actuation area 102, etc. Correspondingly, when the key labeled ‘1’ is actuated, an electrical contact is established between the row trace 116 and each one of the column traces 111 and 112 in the actuation area 101. Similarly, when the key labeled ‘2’ is actuated, an electrical contact is established between the row trace 116 and each one of the column traces 111 and 113 in the actuation area 102, etc.

In the keypad matrix of the exemplary embodiment explained with reference to FIGS. 7 and 8, at least two column traces are respectively coupled to each one of the actuation areas. Thereby, in the exemplary embodiment, actuation up to ten keys may be discriminated with a keypad matrix which has five column traces and one row trace.

While the exemplary keypad matrix 100 illustrated in FIG. 8 comprises one row trace, a larger number of row traces can be implemented in other embodiments. For illustration rather than limitation, in another embodiment a plurality of row traces may be coupled to actuation areas, each of which is respectively coupled to at least two column lines in a manner similar to the coupling scheme illustrated in FIG. 8.

Portions of conductive traces that extend into an actuation area may have a configuration that allows an electrical contact to be established between the conductive traces when the associated key is actuated.

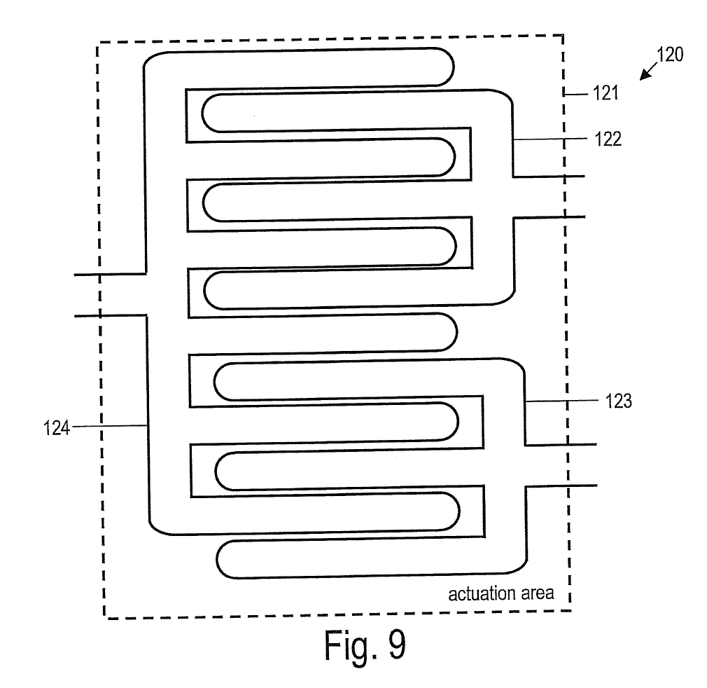

FIG. 9 is a schematic illustration 120 showing portions of conductive traces which extend into an actuation area. Configurations as illustrated in FIG. 9 can be used in the actuation area 49 of FIG. 3, in the actuation area 65 of FIGS. 4-6 or in the actuation areas 101-110 of FIG. 8. The portions 122, 123 and 124 of three conductive traces extend into the actuation area 121. In an embodiment, the portions 122 and 123 may be portions of column traces, and the portion 124 may be a portion of a row trace of a keypad matrix. In another embodiment, the portions 122 and 123 may be portions of row traces, and the portion 124 may be a portion of a column trace of the keypad matrix.

In the illustrated actuation area 121, the portions 122-124 of the conductive traces that extend into the actuation area 121 respectively comprise a plurality of finger-shaped extensions. The fingers of the portion 122 are arranged so as to be interlaced with fingers of the portion 124. Similarly, the fingers of the portion 123 are arranged so as to be interlaced with fingers of the portion 124. When a conductive material is brought into abutment with the actuation area 121 upon actuation of the respective key, an electrical contact may be established between the fingers of the portion 122 and the fingers of the portion 124, and between the fingers of the portion 123 and the fingers of the portion 124, respectively.

While in the exemplary configuration of FIG. 9 portions of conductive traces extending into the actuation area are configured as interlacing fingers, other geometrical arrangements may be implemented in other embodiments.

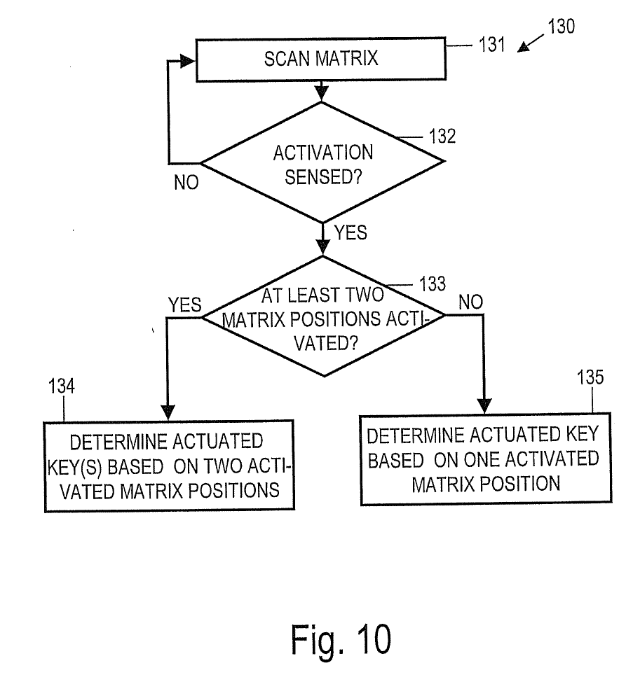

FIG. 10 is a flow diagram representation of a method 130 of determining which key of a keypad has been actuated. The method may be performed by a processor. The processor may be integrated with the keypad, or may be integrated in an electronic device which comprises the keypad. In an embodiment, the method 130 may be performed by the processor 14 of the portable electronic device 10 of FIG. 1. In another embodiment, the method 130 may be performed by the processor 39 of the keypad 20 of FIG. 2.

At 131, a scan of the keypad matrix is performed. In order to scan the matrix, a voltage may be applied between terminals of a row trace and a column trace connected to the processor. The scan over different row traces and over different column traces may be performed sequentially. For each pair of column and row traces, the scanning may comprise performing an electrical current or resistance measurement.

At 132, it is determined whether activation of a matrix position has been sensed at 131. In an embodiment, a matrix position defined by a row trace and a column trace of the keypad matrix is activated when an electrical contact is established between the respective row trance and column trace. If it is determined that no matrix position is activated, the method 130 return to the scanning at 131.

If it is determined that a matrix position is activated, at 133 the processor determines whether at least two matrix positions are activated. If it is determined at 133 that only one matrix position is activated, at 135 the processor determines the actuated key based on the activated matrix position. In an embodiment, the determining at 135 may comprise a table look-up. The table may have entries indicating which key corresponds to which singly activated matrix position. The table may further have entries that allow the respective key to be identified when one matrix position is activated.

If it is determined at 133 that two or more matrix positions are activated, at 134 the processor determines the actuated key(s) based on the activated matrix positions. In an embodiment, the determining at 134 may comprise a table look-up. The table may comprise entries indicating to which key the plural activated matrix positions correspond. The determining at 134 may comprise verifying that the plural activated matrix positions identified when scanning the matrix correspond to a single key. If this verification fails, i.e., when the plural activated matrix positions do not correspond to a single key, this may indicate that more than one key has been simultaneously actuated. In this case, another table look-up may be performed to identify the plural actuated keys that give rise to the plural activated matrix positions.

While keypads and keypad matrices according to various embodiments have been described, it is to be understood that various changes and modifications may be implemented in other embodiments. For illustration rather than limitation, while key arrangements having a specific number of keys and keypad matrices having a specific number of row and column traces have been explained, any other number of keys, row traces and column traces may be implemented in other embodiments. The number of keys, row traces and column traces may be selected based on the requirements of the contemplated field of application of the keypad. For example, keypad matrix designs in which at least three conductive traces are coupled to an actuation area may also be implemented with larger keypad matrices, such as keypad matrices having eight column traces and eight row traces. The size of the keypad matrix may be selected based on the processing capabilities of the processor coupled to the traces of the matrix. In one exemplary embodiment, the keypad may be configured to have a number of keys which is sufficiently large to support an alphanumerical QWERTY keyboard.

While actuation areas coupled to two or three conductive traces, respectively, have been illustrated in some embodiments, actuation areas may also be coupled to more than three conductive traces in other embodiments. For illustration, the keypad matrix may be configured such that actuation of a key activates three or more matrix positions, for example, by establishing electrical contacts between two column traces and two row traces. Further, while actuation areas having an approximately rectangular shape are illustrated in some drawings, the shape of the actuation area is not in any way limited.

While some embodiments have been described in the context of keypads in which an electrical contact is established between a row trace and a column trace to activate a matrix position, activation of a matrix position may also be implemented differently, for example, by modifying a capacitance of conductive traces extending into the associated actuation area. Further, while in some of the described embodiments the keypad matrix is implemented on a printed circuit board, part or all of the keypad matrix may also be integrally formed with the key arrangement. For illustration rather than limitation, row traces of the keypad matrix may be provided on a printed circuit board, while column traces of the keypad matrix may be arranged on the key arrangement, or vice versa.

It is to be understood that the features of the various embodiments may be combined with each other. For illustration rather than limitation, a configuration of conductive traces as shown in FIG. 9 may be implemented in the keypad matrices of FIG. 2, FIGS. 4-6 and FIG. 8, respectively. Those skilled in the art will thus appreciate from the foregoing description that the teachings of the present invention can be implemented in a variety of forms.

The keypads and keypad matrices according to various embodiments may be used in various electronic devices, including portable electronic devices. Exemplary devices in which the keypads and keypad matrices may be used include, but are not limited to, a mobile phone, a personal digital assistant (PDA), a portable music player, a camera and the like.

While specific exemplary embodiments of the invention are disclosed herein, various changes and modifications can be made in other embodiments without departing from the scope of the invention. The present embodiments are to be considered in all respect as illustrative and non-restrictive, and the scope of the invention is intended to be limited only by the appended claims and equivalents thereof.

What is claimed is:

1. A keypad, comprising:
a key arrangement comprising a plurality of keys; and
a matrix arranged in proximity to said key arrangement and comprising a plurality of conductive traces;
wherein said key arrangement is configured such that upon actuation of a key of said plurality of keys electrical characteristics of said matrix are affected in an actuation area of said matrix associated with said key;
wherein said matrix is configured such that at least three conductive traces of said plurality of conductive traces are coupled to said actuation area.

2. The keypad of claim 1,
wherein said plurality of conductive traces comprises a plurality of first conductive traces and a second conductive trace, wherein said second conductive trace is electrically insulated from said plurality of first conductive traces in a state in which no key is actuated.

3. The keypad of claim 2,
wherein said at least three conductive traces comprise said second conductive trace and at least two first conductive traces of said plurality of first conductive traces.

4. The keypad of claim 3,
wherein said matrix is configured such that upon actuation of said key electrical connections are established between said second conductive trace and each first conductive trace of said at least two first conductive traces.

5. The keypad of claim 4, further comprising:
a processor coupled to said at least two first conductive traces and to said second conductive trace and configured to detect that said electrical connections are established.

6. The keypad of claim 3,
wherein said matrix comprises another actuation area associated with another key, wherein said second conductive trace and one conductive trace of said at least two first conductive traces are coupled to said other actuation area of said matrix.

7. The keypad of claim 6,
wherein said actuation area and said other actuation area are spatially disjoint.

8. The keypad of claim 1,
wherein said key arrangement comprises a first set of keys and said matrix comprises a first set of actuation areas associated with said first set of keys,
wherein said matrix is configured such that respectively at least three conductive traces of said plurality of conductive traces are coupled to each actuation area of said first set of actuation areas.

9. The keypad of claim 1,
wherein said key arrangement comprises a second set of keys and said matrix comprises a second set of actuation areas associated with said second set of keys,
wherein said matrix is configured such that respectively two conductive traces of said plurality of conductive traces are coupled to each actuation area of said second set of actuation areas.

10. A portable electronic device, comprising:
a keypad, said keypad comprising:
a key arrangement comprising a plurality of keys; and
a matrix arranged in proximity to said key arrangement and comprising a plurality of conductive traces;
wherein said key arrangement is configured such that actuation of a key of said plurality of keys affects electrical characteristics of said matrix in an actuation area of said matrix associated with said key;
wherein said matrix is configured such that at least three conductive traces of said plurality of conductive traces are coupled to said actuation area.

11. A keypad matrix, comprising:
a plurality of first conductive traces; and
a second conductive trace electrically insulated from said plurality of first conductive traces;
wherein said keypad matrix comprises a plurality of actuation areas;
wherein at least two first conductive traces of said plurality of first conductive traces and said second conductive trace are coupled to an actuation area of said plurality of actuation areas.

12. The keypad matrix of claim 11,
wherein said plurality of actuation areas are spatially disjoint.

13. The keypad matrix of claim 11,
wherein conductive extensions of said at least two first conductive traces are interlaced with conductive extensions of said second conductive trace in said actuation area.

14. The keypad matrix of claim 11,
wherein one first conductive trace of said at least two first conductive traces and said second conductive trace are coupled to another actuation area of said plurality of actuation areas.

15. The keypad matrix of claim 11,
wherein said matrix comprises a first set of actuation areas, wherein respectively at least two first conductive traces of said plurality of first conductive traces and said second conductive trace are coupled to each actuation area of said first set of actuation areas.

16. The keypad matrix of claim 15,
wherein said matrix comprises a second set of actuation areas, wherein respectively one first conductive trace of said plurality of first conductive traces and said second conductive trace are coupled to each actuation area of said second set of actuation areas.

17. A method of determining a user input to a keypad, said method comprising:
providing a keypad comprising a plurality of keys and a keypad matrix, wherein said keypad matrix comprises a plurality of conductive traces;
monitoring electrical characteristics of said matrix;
identifying at least three conductive traces of said plurality of conductive traces based on said monitoring; and
determining a key of said plurality of keys based on said identified at least three conductive traces.

18. The method of claim 17,
wherein said determining comprises verifying that said identified at least three conductive traces are coupled to an actuation area associated with a key of said plurality of keys.

19. The method of claim 17,
wherein said identifying comprises determining whether a resistance of a current flow path comprising two conductive traces of said at least three conductive traces is varied.
